(19) United States
(12) Patent Application Publication
(10) Pub. No.: US 2014/0252755 A1
(43) Pub. Date: Sep. 11, 2014

(54) MULTIPOSITIONAL FITTING

(71) Applicants: Adrian Murias, Mercer Island, WA (US); Ronald A. Decoteau, Carnation, WA (US)

(72) Inventors: Adrian Murias, Mercer Island, WA (US); Ronald A. Decoteau, Carnation, WA (US)

(73) Assignee: PACCAR Inc, Bellevue, WA (US)

(21) Appl. No.: 13/790,782

(22) Filed: Mar. 8, 2013

(51) Int. Cl. F16L 19/00

(52) U.S. Cl. CPC F16L 19/00
USPC 285/24

(57) ABSTRACT

A fitting assembly for connecting a first tube to a second tube includes first and second end fittings fixedly coupled to the first and second tubes, respectively. The first end fitting has a first aperture and a first sealing surface. The second end fitting is sized to be at least partially received within the first aperture and includes a second aperture extending through the second end fitting. The second end fitting further includes a second sealing surface. A seal is disposed between the first sealing surface and the second sealing surface. A lock fitting is slidingly associated with the second tube, and is also rotatable about the second tube. The lock fitting selectively engages the second fitting to compress the seal between the first and second sealing surface.

### BACKGROUND

Some vehicle systems utilize formed rigid tubing as conduits to move pressurized fluids from one portion of the system to another. For example, a vehicle's air conditioning system may include formed metal tubing to supply coolant (refrigerant) from one component to the next. Traditionally, connections between tubing sections have included O-ring seals to prevent leakage. Such connections, however, were prone to leaks, as the O-ring seals were not durable.

An improvement over rubber O-ring seals was achieved with the introduction of slim-line sealing washers. These sealing washers utilize a rubber sealing material lining interior edge of a metal washer. To connect two rigid tubes together, a block is brazed to the end of each tube. The sealing washer is seated in a recess formed in one of the blocks, and then the blocks are coupled together, typically with a single fastener extending though both blocks. The sealing washer is compressed between the blocks, sealing the connection between the tubes. The compression of the rubber sealing material is limited by the metal washer, so that a predictable and repeatable maximum compression is achieved.

Known slim-line connections offer improved durability and sealing capability over O-ring connections; however, they are not without their drawbacks. As previously noted, slim-line connections typically have a block brazed or otherwise fixedly secured to the end of each tube. Because the blocks must be aligned to complete the connection, most installations require that the block be aligned in a precise orientation, particularly when the tube is not a straight run. This requires tooling and jigs to make sure that the blocks will be properly positioned to allow the connection to be made when the tube run is installed. The need for tooling and jigs, as well as the possibility of misaligned blocks, adds to the time and cost required to manufacture the tubes.

### SUMMARY

An exemplary embodiment of a fitting assembly is claimed in accordance with aspects of the present disclosure. The fitting assembly is suitable for connecting a first tube to a second tube. The fitting assembly includes a first end fitting fixedly coupled to an end of the first tube, and a second end fitting fixedly coupled to an end of the second tube. The first end fitting has a first aperture with a first end sized to receive an end of the first tube. The first end fitting also includes a first sealing surface. The second end fitting is sized to be at least partially received within a second end of the first aperture and includes a second aperture extending through the second end fitting. The second end fitting further includes a second sealing surface. A seal is disposed between the first sealing surface and the second sealing surface. A lock fitting is slidingly associated with the second tube, and is also rotatable about the second tube. The lock fitting selectively engages the second fitting to compress the seal between the first and second sealing surface.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a perspective view of a fitting assembly for connecting two tubes in accordance with the present disclosure;

FIG. 2 is an exploded perspective view of the fitting assembly of FIG. 1;

FIG. 3 is a cross-sectional view of the fitting assembly of FIG. 1; and

FIG. 4 is an exploded cross-sectional view of the fitting assembly of FIG. 1.

### DETAILED DESCRIPTION

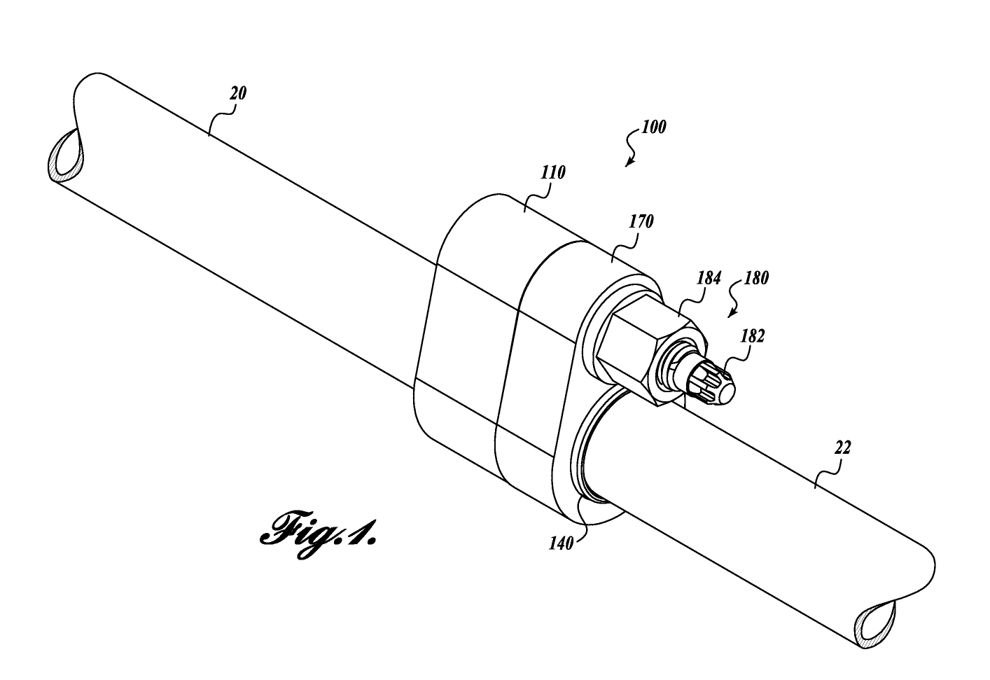

FIG. 1 shows a first tube 20 connected to a second tube 22 by an exemplary embodiment of a fitting assembly 100. The first and second tubes 20 and 22 are formed from stainless steel rigid tubing commonly used in HVAC systems and the like. The fitting assembly 100 provides a fluid-tight connection between the first and second tubes 20 and 22 that is suitable for typical pressurized applications.

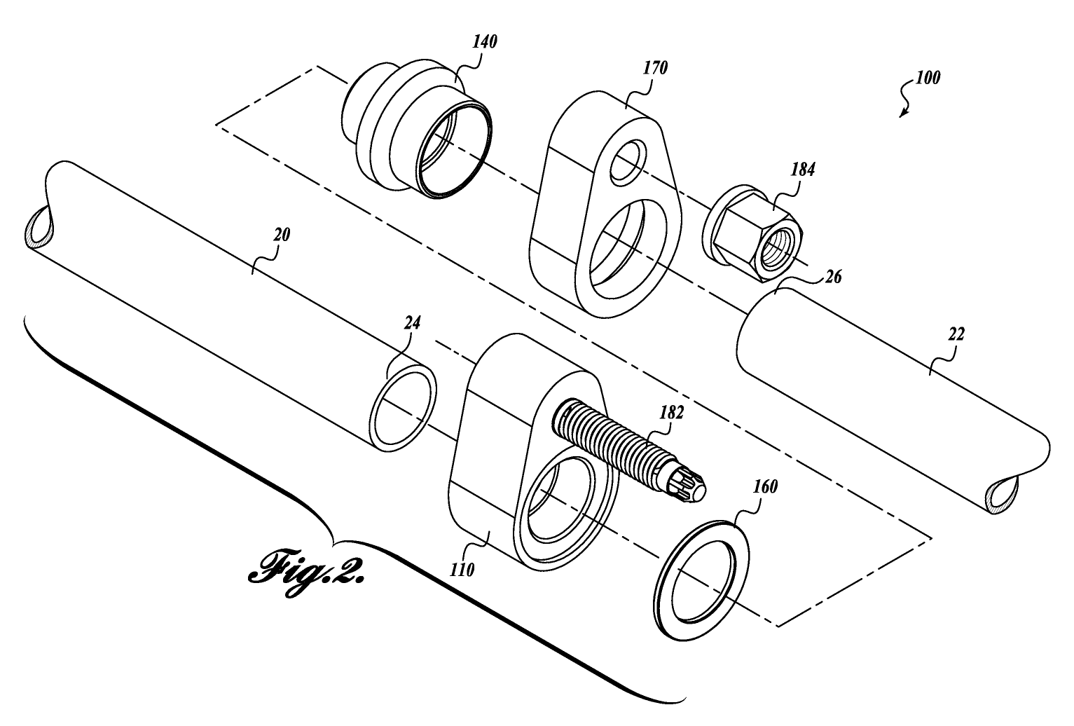

Referring to FIGS. 2-4, a first end fitting 110 is fixedly coupled to a first end 24 of the first tube 20 such that there is a fluid-tight seal between the first tube 20 and the first end fitting 110. The first end fitting 110 includes an aperture 112 extending therethrough. A first end 114 of the aperture 112 is sized and configured to receive the first end 24 of the first tube 20. In the illustrated embodiment, a shoulder 118 is formed in the aperture 112 to act as a stop that positions the first tube 20 within the aperture 112. The first end fitting 110 is coupled to the first tube 20 such that the first end 24 of the first tube is disposed within the aperture 112 with the end of the first tube located proximate to the shoulder 118. The first end fitting 110 is secured to the first tube 120 by brazing, welding, adhesive, or any other suitable manner.

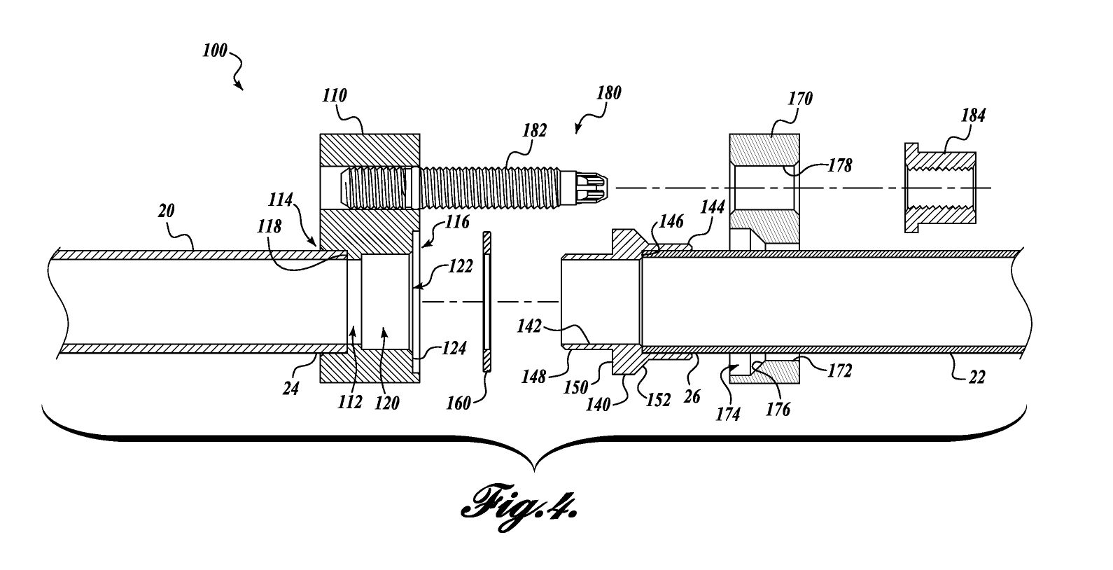

A cavity 120 is formed in second end 116 of the aperture 112. The cavity 118 is sized and configured to receive a portion of a second end fitting 140, described hereinafter. As best shown in FIG. 4, a recess 122 is formed in the second end 116 of the aperture 112 and defines a first sealing surface 124. The recess 120 is sized to receive a seal 160 partially therein. The seal 160 is preferably a slim-line washer; however, it will be appreciated that an O-ring gasket can be utilized instead of, or in conjunction with, the slim-line washer.

Still referring to FIGS. 2-4, a second end fitting 140 is fixedly coupled to a first end 26 of the second tube 22 such that there is a fluid-tight seal between the second tube 22 and the second end fitting 140. The second end fitting 140 includes an aperture 142 extending therethrough, wherein at a first end 144 of the second end fitting 140 the aperture is sized and configured to receive the first end 26 of the second tube 22. In the illustrated embodiment, a shoulder 146 is formed in the aperture 142 to act a stop that positions the second tube 22 within the aperture 142. The second end fitting 140 is coupled to the second tube 22 such that the first end 26 of the second tube is disposed within the aperture 142 with the end of the first tube located proximate to the shoulder 146. The first end fitting 140 is secured to the first tube 122 by brazing, welding, adhesive, or any other suitable manner.

A second end 148 of the second end fitting 140 is sized and configured to be received within the cavity 120 of the first end fitting 112. A shoulder formed on the second end fitting 140 defines a second sealing surface 150 that opposes the first sealing surface 124 when the second end 148 of the second end fitting 140 is inserted into the cavity 120 of the first end fitting 110. Disposed between the first and second ends 144 and 148 of the second end fitting 140 is a tapered surface 152 that extends around the outer perimeter of the second fitting 140. The tapered surface 152 generally faces outwardly in the direction of the first end 144 of the second fitting.

A lock fitting 170 has an aperture 172 sized to allow the second tube 22 to pass therethrough. A first end of the aperture 172 includes a recess 174 sized and configured to receive a portion of the first end 144 of the second end fitting 140. The recess 174 includes a tapered surface 176 that corresponds to the tapered surface 152 of the second end fitting 140.

The fitting assembly 100 further includes a lock mechanism 180 to selectively secure the first end fitting 110 to the second end fitting 140. In the illustrated embodiment, the lock mechanism 180 includes a threaded stud 182 extending from the first end fitting 110 toward the lock fitting 170. The lock fitting 170 includes a hole 178 sized to allow the threaded stud 182 to pass therethrough when the second end 148 of the second end fitting 140 is disposed within the cavity 120 of the first end fitting 110. The lock mechanism 180 further includes a nut 184 to engage the threaded stud 182 to secure the lock fitting 170 to the first end fitting 110.

It will be appreciated that the illustrated lock mechanism 180 is exemplary only and should not be considered limiting. In this regard, embodiments are contemplated wherein the threaded stud extends from the lock fitting through a hole formed in the first end fitting. Moreover, the lock mechanism 180 is not limited to any particular fastener, but can include any type of fastener suitable for selectively coupling the lock fitting to the first end fitting 110. These and other configurations for selectively coupling the lock fitting 170 to the first end fitting 110 are contemplated and should be considered within the scope of the present disclosure.

FIG. 4 shows one embodiment of the fitting assembly 100 in an uncoupled position. To couple the first tube 20 to the second tube 22, the cavity 120 of the first end fitting 110 is aligned longitudinally with the second end 148 of the second end fitting 140. Because the second end 148 of the second end fitting 140 has a cylindrical outer profile, it is not necessary to align the second fitting 140 about its central axis. That is, the second end fitting 140 does not need to be “clocked” to a particular orientation about its central axis in order to engage the first end fitting 110.

With the first and second end fittings 110 and 140 aligned along the longitudinal axis, the seal 160 is placed between the first and second sealing surfaces 124 and 150, and the second end 148 of the second end fitting 140 is inserted into the cavity 120 of the first end fitting 110. The lock fitting 170, which is (1) slidable along the second tube 22 and (2) rotatable about the central axis of the second tube is then positioned so that the hole 178 of the lock fitting 170 is aligned with the threaded stud 182 extending from the first end fitting 110. The lock fitting 170 is moved toward the first end fitting 110 so that the threaded stud 182 extends through the hole 178 of the lock fitting 170 and the first end 144 of the second end fitting 140 is received by the recess 174 formed in the lock fitting 170. The connection is completed by fastening the nut 184 to the threaded rod 182 to secure the first end fitting 110 to the second end fitting 140.

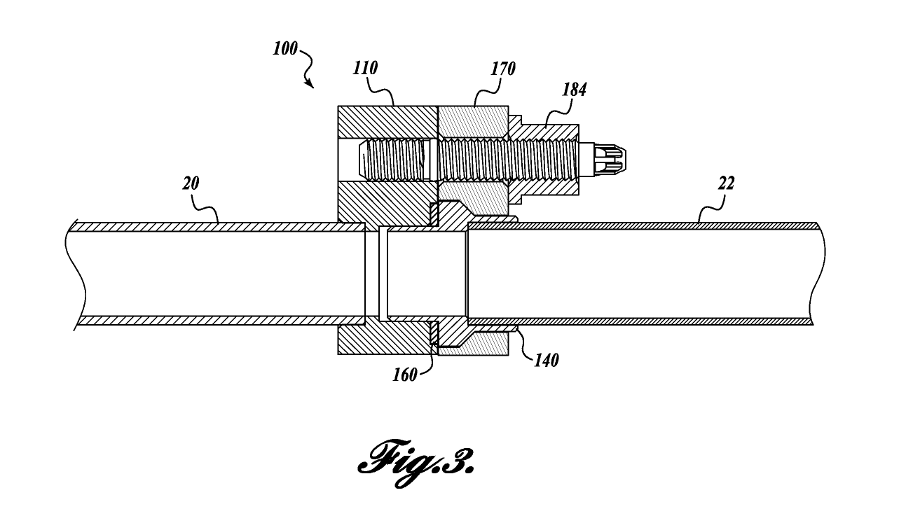

As best shown in FIG. 3, when the lock fitting 170 is secured to the first end fitting 110, the engagement of the lock fitting 170 with the second end fitting 140 biases the second end fitting toward the first end fitting. This, in turn, compresses the seal 160 between the first and second sealing surfaces 124 and 150 to create a fluid-tight connection between the first and second tubes 20 and 22.

In addition to maintaining compression of the seal 160, the engagement of the lock fitting 170 with the second end fitting 140 centers the second end fitting in the joint. In this regard, as the second end fitting 140 is received within the recess 174 of the lock fitting 170, the tapered surface 152 on the second end fitting engages the tapered surface 176 in the recess of the lock fitting. As the second end fitting 140 becomes fully seated within the lock fitting 170, the interaction of the frustoconical tapered surface 152 of the second fitting 140 with the frustoconical tapered surface 176 of the lock fitting aligns the second fitting with the lock fitting and, therefore, the first end fitting 110. This self-aligning feature helps to ensure that an even pressure is applied to the seal 160 by the first and second sealing surfaces 124 and 150.

While illustrative embodiments have been illustrated and described, it will be appreciated that various changes can be made therein without departing from the spirit and scope of the invention.

The embodiments of the invention in which an exclusive property or privilege is claimed are defined as follows:

1. A fitting assembly for connecting a first tube to a second tube, the fitting assembly comprising:
(a) a first end fitting fixedly coupled to an end of the first tube, the first end fitting comprising:
(i) a first aperture extending through the first end fitting, a first end of the first aperture sized to receive an end of the first tube; and
(ii) a first sealing surface;
(b) a second end fitting fixedly coupled to an end of the second tube and sized to be at least partially received within a second end of the first aperture, the second end fitting comprising:
(i) a second aperture extending through the second end fitting, a first end of the second aperture sized to receive an end of the second tube; and
(ii) a second sealing surface;
(c) a seal disposed between the first sealing surface and the second sealing surface; and
(d) a lock fitting slidingly associated with the second tube, the lock fitting being rotatable about the second tube, the lock fitting selectively engaging the second fitting to compress the seal between the first and second sealing surface.

2. The fitting assembly of claim 1, further comprising a locking mechanism, the locking mechanism selectively securing the first end fitting to the lock fitting.

3. The fitting assembly of claim 2, the locking mechanism comprising:
(a) a threaded stud fixedly coupled to the first end fitting;
(b) an aperture formed in the lock fitting, the aperture sized to receive the threaded stud; and
(c) a nut selectively engaging the threaded stud, the nut maintaining engagement of the first end fitting with the lock fitting.

4. The fitting assembly of claim 2, the locking mechanism comprising:
(a) a threaded stud fixedly coupled to the lock fitting;
(b) an aperture formed in the first end fitting, the aperture sized to receive the threaded stud; and
(c) a nut selectively engaging the threaded stud, the nut maintaining engagement of the first end fitting with the lock fitting.

5. The fitting assembly of claim 2, the first end fitting comprising a recess, an end of the recess defining the first sealing surface.

6. The fitting assembly of claim 2, the second end fitting comprising a shoulder defining the second sealing surface.

7. The fitting assembly of claim 2, wherein a second end of the first aperture is sized and configured to receive a second end of the second end fitting.

8. The fitting assembly of claim 2, wherein the second end fitting comprises a first tapered surface.

9. The fitting assembly of claim 8, wherein the lock fitting comprises a second tapered surface, the second tapered surface engaging the first tapered surface when the fitting assembly is in a locked position.

10. The fitting assembly of claim 9, wherein the first tapered surface is frustoconical surface.

11. The fitting assembly of claim 10, wherein the second tapered surface is frustoconical surface.
